(19) United States
(12) Patent Application Publication
(10) Pub. No.: US 2026/0192635 A1
(43) Pub. Date: Jul. 9, 2026

(54) AIRFLOW DIRECTION ADJUSTMENT APPARATUS

(71) Applicant: NIHON PLAST CO., LTD., Fujinomiya-shi (JP)

(72) Inventor: Yojiro Yoneyama, Shizuoka (JP)

(21) Appl. No.: 19/430,385

(22) Filed: Dec. 23, 2025

(30) Foreign Application Priority Data
Jan. 7, 2025 (JP) 2025-002228

(51) Int. Cl. B60H 1/34

(52) U.S. Cl. CPC B60H 1/3421; B60H 2001/3471

(57) ABSTRACT

An airflow direction adjustment apparatus with a simple configuration that allows only one fin to rotate. The airflow direction adjustment apparatus includes: a ventilation passage; a first fin that has a rotational axis in a first direction intersecting a ventilation direction of the ventilation passage, and changes an airflow direction by rotating; a second fin that has a rotational axis in a second direction intersecting the ventilation direction and the first direction, and changes an airflow direction by rotating; drive means; a first drive portion for rotating the first fin by receiving driving force from the drive means and rotating; a second drive portion that has a rotational axis along the first drive portion and rotates the second fin by rotating; and transmission switching means capable of switching between a transmissive state in which the first drive portion transmits the driving force received from the drive means to the second drive portion, and a non-transmissive state in which the first drive portion does not transmit the driving force received from the drive means to the second drive portion.

### CROSS REFERENCE TO RELATED APPLICATIONS

The present application claims priority to, and contains subject matter to, JP2025-002228, filed on Jan. 7, 2025, the entire contents of each of which incorporated herein by reference.

### TECHNICAL FIELD

The present invention relates to an airflow direction adjustment apparatus including a first fin and a second fin.

### BACKGROUND ART

Conventionally, with an electric airflow direction adjustment apparatus that rotates fins by receiving driving force from a motor, using a separate motor for each fin with a different rotational axis direction leads to increased cost. For this reason, an apparatus is known that controls two-axis fins with a simple structure using a single motor, for example, by converting the direction of the driving force from the motor using a bevel gear (for example, see PTL 1).

### CITATION LIST

### Patent Literature

PTL 1
Japanese Patent Application Laid-Open No.4-113852

### SUMMARY OF INVENTION

### Technical Problem

However, in the case of the above-described configuration, since the bevel gears constantly mesh, rotating one fin causes the other fin to rotate simultaneously, making it impossible to operate only one predetermined fin.

The present invention has been made in view of such circumstances, and an object thereof is to provide an airflow direction adjustment apparatus with a simple configuration that allows only one fin to rotate.

### Solution to Problem

An airflow direction adjustment apparatus according to an aspect of the present invention includes: a ventilation passage; a first fin that has a rotational axis in a first direction intersecting a ventilation direction of the ventilation passage and changes an airflow direction by rotating; a second fin that has a rotational axis in a second direction intersecting the ventilation direction and the first direction, and changes an airflow direction by rotating; drive means; a first drive portion that rotates upon receiving driving force from the drive means and rotates the first fin; a second drive portion that has a rotational axis along the first drive portion and rotates the second fin by rotating; and transmission switching means capable of switching between a transmissive state in which the first drive portion transmits the driving force received from the drive means to the second drive portion, and a non-transmissive state in which the first drive portion does not transmit the driving force received from the drive means to the second drive portion.

### Advantageous Effects of Invention

According to the present invention, it is possible to rotate only one fin with a simple configuration.

### BRIEF DESCRIPTION OF DRAWINGS

FIG. 1 is an exploded perspective view showing an internal structure of an airflow direction adjustment apparatus according to Embodiment 1 of the present invention;

FIG. 2 is a perspective view showing a part of a first drive portion and transmission switching means of the airflow direction adjustment apparatus;

FIG. 3 is a perspective view showing an internal structure of the airflow direction adjustment apparatus;

FIG. 4 is a perspective view showing an example of the appearance of the airflow direction adjustment apparatus;

FIG. 5 is a chart showing an example of the relationship between the rotation angle of drive means of the airflow direction adjustment apparatus and the rotation angles of a first fin and a second fin;

FIG. 6A is a front view showing an example of the positional relationship between an abutment portion and an abutment target portion of transmission switching means when the rotation angle of the drive means is in the range of ±90°, FIG. 6B is a side view showing the operating state of the second fin corresponding to FIG. 6A, and FIG. 6C is a plan view showing the operating state of the first fin corresponding to FIG. 6A;

FIG. 7A is a front view showing an example of the positional relationship between an abutment portion and an abutment target portion of transmission switching means when the rotation angle of the drive means is in the range of 140° to 230°, FIG. 7B is a side view showing the operating state of the second fin corresponding to FIG. 7A, and FIG. 7C is a plan view showing the operating state of the first fin corresponding to FIG. 7A;

FIG. 8A is a front view showing an example of the positional relationship between an abutment portion and an abutment target portion of transmission switching means when the rotation angle of the drive means is in the range of 230° to 320°, FIG. 8B is a side view showing the operating state of the second fin corresponding to FIG. 8A, and FIG. 8C is a plan view showing the operating state of the first fin corresponding to FIG. 8A;

FIG. 9A is a front view showing an example of the positional relationship between an abutment portion and an abutment target portion of transmission switching means when the rotation angle of the drive means is in the range of 320° to 410°, FIG. 9B is a side view showing the operating state of the second fin corresponding to FIG. 9A, and FIG. 9C is a plan view showing the operating state of the first fin corresponding to FIG. 9A;

FIG. 10 is an exploded perspective view showing an internal structure of an airflow direction adjustment apparatus according to Embodiment 2 of the present invention;

FIG. 11 is a perspective view showing a part of a first drive portion and transmission switching means of the airflow direction adjustment apparatus;

FIG. 12 is a perspective view showing link transmission switching means of the airflow direction adjustment apparatus;

FIG. 13 is a perspective view showing an internal structure of the airflow direction adjustment apparatus;

FIG. 14 is a perspective view showing the airflow direction adjustment apparatus with a part of a case body cut away;

FIG. 15A is a front view showing an example of the positional relationship between the abutment portion and the abutment target portion of the transmission switching means in a range in which the rotation angle of the drive means exceeds 140°, FIG. 15B is a front view showing an example of the positional relationship between the abutment portion and the abutment target portion of the link transmission switching means corresponding to FIG. 15A, and FIG. 15C is a side view showing the operating state of the second fin corresponding to FIG. 15B;

FIG. 16A is a front view showing an example of the positional relationship between the abutment portion and the abutment target portion of the transmission switching means at the rotation angle of the drive means, following FIG. 15A, FIG. 16B is a front view showing an example of the positional relationship between the abutment portion and the abutment target portion of the link transmission switching means corresponding to FIG. 16A, and FIG. 16C is a side view showing the operating state of the second fin corresponding to FIG. 16B;

FIG. 17A is a front view showing an example of the positional relationship between the abutment portion and the abutment target portion of the transmission switching means at the rotation angle of the drive means, following FIG. 16A, FIG. 17B is a front view showing an example of the positional relationship between the abutment portion and the abutment target portion of the link transmission switching means corresponding to FIG. 17A, and FIG. 17C is a side view showing the operating state of the second fin corresponding to FIG. 17B;

FIG. 18A is a front view showing an example of the positional relationship between the abutment portion and the abutment target portion of the transmission switching means at the rotation angle of the drive means, following FIG. 17A, FIG. 18B is a front view showing an example of the positional relationship between the abutment portion and the abutment target portion of the link transmission switching means corresponding to FIG. 18A, and FIG. 18C is a side view showing the operating state of the second fin corresponding to FIG. 18B; and

FIG. 19A is a front view showing an example of the positional relationship between the abutment portion and the abutment target portion of the transmission switching means when the drive means rotates in the opposite direction, FIG. 19B is a front view showing an example of the positional relationship between the abutment portion and the abutment target portion of the link transmission switching means corresponding to FIG. 19A, and FIG. 19C is a side view showing the operating state of the second fin corresponding to FIG. 19B.

### DESCRIPTION OF EMBODIMENTS

Hereinafter, Embodiment 1 of the present invention will be described with reference to the drawings.

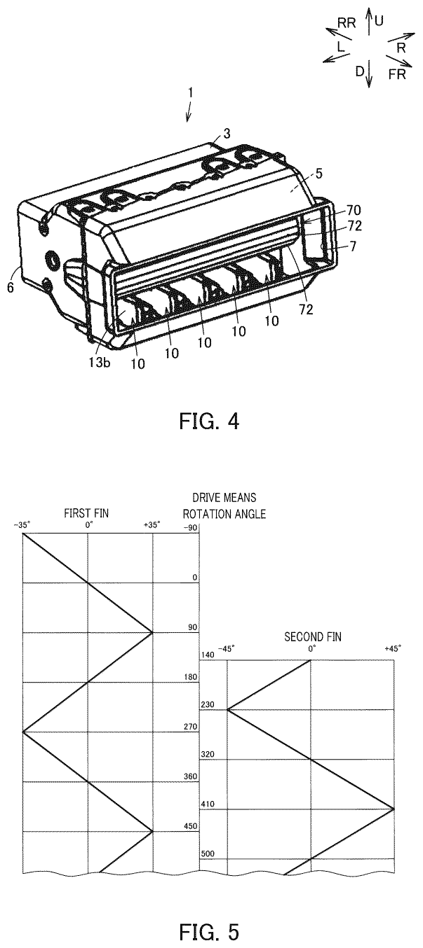

In FIG. 4, reference number 1 represents an airflow direction adjustment apparatus. Airflow direction adjustment apparatus 1 is also called an air outlet, a ventilator, a register, or the like, and adjusts the direction in which air is blown out from an air conditioner or the like. To make the description clearer below, airflow direction adjustment apparatus 1 defines the front, front side or near side as the downwind side from which the air blows out, and the rear side, back side or far side as the opposite side, that is, the upwind side that receives the air, thereby defining the left-right direction or width direction as viewed from the rear side, and the up-down direction. In the present embodiment, airflow direction adjustment apparatus 1 is applied to an air conditioner for a vehicle such as an automobile. Airflow direction adjustment apparatus 1 may be disposed anywhere, but is disposed, for example, on the instrument panel between the driver's seat and the passenger seat. In the drawings, it is assumed that arrow FR side is the front side, arrow RR side is the rear side, arrow L side is the left side, arrow R side is the right side, arrow U side is the upper side, and arrow D side is the lower side. The directions are illustrated only as examples, and may be changed as appropriate depending on an installation position or an installation orientation of airflow direction adjustment apparatus 1.

Airflow direction adjustment apparatus 1 includes a case body 3. Case body 3 is formed in a cylindrical shape. In the present embodiment, case body 3 is formed in the cylindrical shape in the front-rear direction. In the illustrated example, case body 3 is formed in a rectangular cylindrical shape. Case body 3 encloses one and other ventilation passages 5 therein. A direction parallel to a central axis of case body 3 is the ventilation direction of ventilation passage 5. In the present embodiment, the ventilation direction of ventilation passage 5 is in the front-rear direction, and ventilation is performed from the rear toward the front. That is, in ventilation passage 5, the rear side is an upstream side in the ventilation direction, and the front side is a downstream side in the ventilation direction. Ventilation passage 5 has a square cross-section perpendicular to the ventilation direction.

At the rear end portion of case body 3, one and other intake ports 6 are formed to receive air, that is, conditioned air, into the ventilation passage 5, and at the front end portion of case body 3, one and other exhaust ports 7 are formed to discharge conditioned air from the ventilation passage 5. Ventilation passage 5 is formed between intake port 6 and exhaust port 7 to connect therebetween. The conditioned air flows from intake port 6 to exhaust port 7.

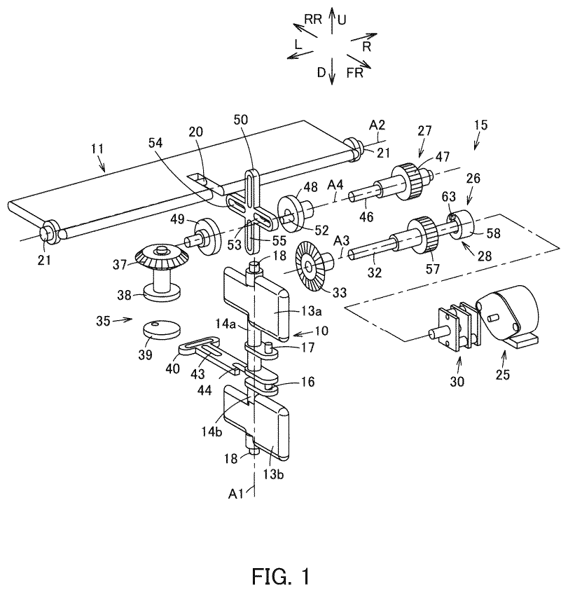

As shown in FIGS. 1 to 4, first fin 10 and second fin 11 are disposed inside case body 3, that is, in ventilation passage 5, so as to be able to rotate (swing). First fin 10 and second fin 11 are also called louvers, and rotate relative to case body 3 to adjust the direction of the conditioned air blown out from exhaust port 7 in accordance with the rotation.

First fin 10 is also called a vertical fin, and has rotational axis A1 in a first direction that intersects or is perpendicular to the front-rear direction, which is the ventilation direction of ventilation passage 5, in the present embodiment, in the up-down direction, is elongated in the up-down direction, and is disposed so as to be rotatable in the left-right direction. First fin 10 is a downstream fin positioned on the front side of second fin 11 on the downstream side of ventilation passage 5 in the ventilation direction, and is positioned facing exhaust port 7 in the present embodiment. In the illustrated example, a plurality of first fins 10 are set and positioned side by side in the left-right direction, which is the longitudinal direction of the cross-section of case body 3 or the ventilation passage 5. The plurality of first fins 10 are coupled to one another via links so as to rotate in unison in the same direction.

In the present embodiment, first fin 10 has flow straightening portions 13a and 13b spaced apart from each other in the up-down direction, which is the first direction. Flow straightening portions 13a and 13b are each substantially plate-shaped, and the main surfaces on both the left and right sides function as flow straightening surfaces. Flow straightening portions 13a and 13b have fin shaft portions 14a and 14b protruding toward each other along rotational axis A1 of first fin 10. These fin shaft portions 14a and 14b are coupled by a coupling shaft portion 16, which is coupled to drive mechanism 15 described later. Coupling shaft portion 16 is not coaxial with the fin shaft portions 14a and 14b, and is positioned, for example, forward of fin shaft portions 14a and 14b. Therefore, fin shaft portion 14a, coupling shaft portion 16, and fin shaft portion 14b are coupled in a crank shape. In addition, link shaft 17 that is coupled to a link is formed on fin shaft portion 14a. Link shaft 17 is not coaxial with fin shaft portion 14a, and is positioned, for example, forward of fin shaft portions 14a and 14b.

In addition, first fin 10 has rotating portions 18 and 18 at both end portions on rotational axis A1. In the present embodiment, rotating portions 18 and 18 are positioned on the opposite side from fin shaft portions 14a and 14b within flow straightening portions 13a and 13b. Rotating portions 18 and 18 are rotatably held by a rotation bearing portion. Rotating portion 18 and the rotation bearing portion are such that one is a shaft portion and the other is a hole portion or a recessed portion. In the present embodiment, each rotating portion 18 has a shaft portion, and each rotation bearing portion is a round hole-shaped hole portion or recessed portion, but the present invention is not limited thereto. One side of rotating portions 18 may be a shaft portion, while the other side may be a hole portion. The rotation bearing portion may be formed on case body 3 or may be formed in a bearing member such as a spacer attached to case body 3.

Second fin 11 is also called a horizontal fin, and has rotational axis A2 in a predetermined second direction that intersects or is perpendicular to both the front-rear direction, which is the ventilation direction of ventilation passage 5, and a predetermined first direction along which rotational axis A1 of first fin 10 is aligned, in the present embodiment, rotational axis A2 in the left-right direction, and is elongated in the left-right direction and disposed so as to be rotatable in the up-down direction. In the illustrated example, one second fin 11 is set and positioned at the central portion in the up-down direction, which is the widthwise direction of the cross-section of case body 3 or ventilation passage 5. Second fin 11 is an upstream fin that is positioned on the upstream side of first fin 10 in the ventilation direction of ventilation passage 5. Second fin 11 is formed in a plate shape, and upper and lower main surfaces thereof function as flow straightening surfaces. In addition, coupling shaft portion 20 to be coupled to drive mechanism 15 is formed at the front portion of second fin 11. Coupling shaft portion 20 is formed as a shaft portion parallel to rotational axis A2 of second fin 11, at the front end portion of second fin 11 and rearward of rotational axis A2. Hereinafter, the term “parallel” includes “substantially parallel”.

Furthermore, second fin 11 has rotating portions 21 and 21 at both end portions on rotational axis A2. Rotating portions 21 and 21 are rotatably held by a rotation bearing portion. Rotating portion 21 and the rotation bearing portion are such that one is a shaft portion and the other is a hole portion or a recessed portion. In the present embodiment, each rotating portion 21 has a shaft portion, and each rotation bearing portion is a round hole-shaped hole portion or recessed portion, but the present invention is not limited thereto. One side of rotating portions 21 may be a shaft portion, while the other side may be a hole portion. The rotation bearing portion may be formed on case body 3 or may be formed in a bearing member such as a spacer attached to case body 3.

Drive mechanism 15 is a mechanism for operating first fin 10 and second fin 11 by one drive means 25. Drive mechanism 15 includes first drive portion 26 for rotating first fin 10, second drive portion 27 for rotating second fin 11, and transmission switching means 28 capable of switching the transmissive state/non-transmissive state between first drive portion 26 and second drive portion 27.

Drive means 25 is an electrically powered type that is driven in response to signals and the like. Drive means 25 uses, for example, a motor, preferably a stepping motor, and is preferably capable of both forward and rearward rotation. Drive means 25 has a rotational axis in, for example, a left-right direction, which is the second direction. In the present embodiment, first drive portion 26 is coupled to drive means 25 via reduction gear 30.

First drive portion 26 rotates by receiving driving force from drive means 25, thereby rotating first fin 10. In the present embodiment, first drive portion 26 has rotational axis A3 along the left-right direction, which is the second direction. In the illustrated example, first drive portion 26 has first shaft portion 32 extending in the left-right direction, which is the second direction, and first gear 33 coupled coaxially to the tip end portion of first shaft portion 32.

First shaft portion 32 is formed, for example, in an elongated cylindrical shape and is disposed coaxially with drive means 25 and reduction gear 30. One end portion of first shaft portion 32 is coupled to drive means 25 via reduction gear 30, and first shaft portion 32 rotates about the central axis in the same direction as the rotation of drive means 25. First shaft portion 32 is rotatable in the front-rear direction, which is the same direction as the rotational direction of drive means 25.

First gear 33 rotates integrally with first shaft portion 32 in the same direction. In the present embodiment, first gear 33 is connected to conversion means 35 that converts the rotation of first drive portion 26 (first shaft portion 32), caused by the driving force received from drive means 25, into rotation of first fin 10.

Conversion means 35 has conversion gear 37 meshing with first gear 33, first crank 38 coaxially disposed with conversion gear 37; first rotating body 39 coupled to first crank 38, and first link body 40 that converts the rotation of conversion means 35 into the rotation of first fin 10 through the rotation of first crank 38.

In the present embodiment, conversion gear 37 and first gear 33 are bevel gears, and conversion gear 37 is disposed with a rotational axis in the up-down direction perpendicular to the rotational axis of first gear 33. That is, the meshing of conversion gear 37 and first gear 33 converts the rotation of first drive portion 26 in the front-rear direction into rotation in the left-right direction. Conversion means 35 may be configured in any manner, as long as the rotation of first drive portion 26 in the front-rear direction can be converted into rotation in the left-right direction.

First crank 38 is coupled to a lower portion of conversion gear 37. First crank 38 is formed in a disk shape. On first crank 38, cam pin 42 is protruding downward. Cam pin 42 is positioned radially away from the central axis of first crank 38. Cam pin 42 is coupled to first rotating body 39 through first link body 40.

First rotating body 39 is formed in a disk shape having a diameter substantially equal to that of first crank 38 and is coupled coaxially with conversion gear 37 and first crank 38.

First link body 40 is formed in a plate shape having a thickness in the up-down direction and extends in the front-rear direction, which is the ventilation direction of the ventilation passage 5. First link body 40 has first cam groove 43 formed therein, which is a long hole extending in the front-rear direction. Cam pin 42 of first crank 38 is slidably and rotatably inserted into first cam groove 43. In addition, first transmission groove 44 is formed as a notch along the front-rear direction at the front end portion of first link body 40. Coupling shaft portion 16 of first fin 10 is slidably and rotatably inserted into first transmission groove 44.

In addition, second drive portion 27 rotates to cause second fin 11 to rotate. Second drive portion 27 has rotational axis A4 along first drive portion 26 and preferably parallel to rotational axis A3 of first drive portion 26. “Along first drive portion 26” means that the directional component parallel to rotational axis A3 of first drive portion 26 is a primary component, and includes not only a state of parallel alignment but also cases such as when the component is in a twisted position. Second drive portion 27 is positioned rearward relative to first drive portion 26 and is disposed between first drive portion 26 and second fin 11. In the present embodiment, second drive portion 27 has second shaft portion 46 having a rotational axis parallel to first shaft portion 32 of first drive portion 26, second gear 47 which is a gear disposed coaxially on the base end portion side of second shaft portion 46, second crank 48 coaxially coupled to the tip end portion side of second shaft portion 46, second rotating body 49 coupled to this second crank 48, and second link body 50 which converts the rotation of second drive portion 27 into rotation of second fin 11 by rotation of second crank 48.

Second shaft portion 46 is formed, for example, as an elongated cylindrical shape. One end portion of second shaft portion 46 is rotatably supported on case body 3 side. In addition, second gear 47 positioned at the base end portion of second shaft portion 46 is formed in, for example, a spur gear shape.

Second crank 48 is coupled coaxially to the tip end portion of second shaft portion 46. Second crank 48 is formed in a disk shape. On second crank 48, cam pin 52 is laterally protruding. Cam pin 52 is positioned radially away from the central axis of second crank 48. Cam pin 52 is coupled to second rotating body 49 through second link body 50.

Second rotating body 49 is formed in a disk shape having a diameter substantially equal to that of second crank 48 and is coupled coaxially with second shaft portion 46 and second gear 47. Second rotating body 49 is rotatably supported on case body 3 side, for example.

Second link body 50 is formed in a plate shape having a thickness in the left-right direction and extends in the front-rear direction and the up-down direction. In the present embodiment, second link body 50 is formed in a cross shape. Second cam groove 53, which is a long hole extending in the front-rear direction, is formed in the front portion of second link body 50. Cam pin 52 of second crank 48 is slidably and rotatably inserted into second cam groove 53. In addition, second transmission groove 54 is formed along the front-rear direction at the rear end portion of second link body 50 facing second fin 11. Second transmission groove 54 has coupling shaft portion 20 of second fin 11 slidably and rotatably inserted therein. In addition, second link body 50 has regulating groove 55 formed as a long hole along the up-down direction to regulate the position of second link body 50. A support shaft protruding from case body 3 side is slidably inserted into regulating groove 55, enabling second fin 11 to rotate stably via second link body 50. The shape of second link body 50 is not limited to a cross shape and may also be a T-shape or the like.

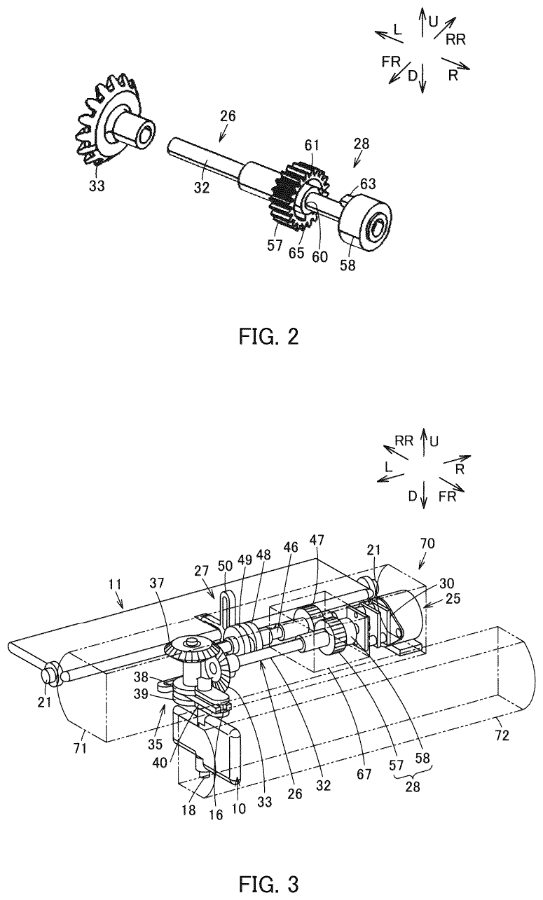

Transmission switching means 28 shown in FIGS. 1 and 2 is capable of switching between a transmissive state in which first drive portion 26 transmits the driving force received from drive means 25 to second drive portion 27, and a non-transmissive state in which first drive portion 26 does not transmit the driving force received from drive means 25 to second drive portion 27.

In the present embodiment, transmission switching means 28 has transmission gear 57 meshing with second gear 47 and clutch body 58 combined with transmission gear 57.

Transmission gear 57 is formed in, for example, a spur gear shape and is disposed coaxially with first shaft portion 32. That is, transmission gear 57 has a rotational axis in the left-right direction. Transmission gear 57 is positioned toward the base end portion of first shaft portion 32 and faces clutch body 58, which is attached coaxially with the base end portion of first shaft portion 32, in close proximity in the left-right direction. Transmission gear 57 is disposed to rotate freely relative to first shaft portion 32. That is, opening portion 60 through which first shaft portion 32 is inserted is formed in the central portion of transmission gear 57, penetrating transmission gear 57 in the axial direction, and the inner diameter dimension of opening portion 60 is larger than the outer diameter dimension of first shaft portion 32 so that a gap is formed between first shaft portion 32 and opening portion 60. Preferably, groove portion 61 is formed around opening portion 60 of transmission gear 57. Groove portion 61 is formed in an arc shape extending in a circumferential direction and is concentric with transmission gear 57. Groove portion 61 is formed on the side surface of transmission gear 57 facing clutch body 58.

In addition, clutch body 58 is coupled coaxially to first shaft portion 32 so as to rotate integrally with first shaft portion 32. Clutch body 58 is formed in, for example, a cylindrical shape. In the present embodiment, clutch body 58 is formed as a separate body from first shaft portion 32, but the present invention is not limited thereto, clutch body 58 may also be formed integrally with first shaft portion 32. Clutch body 58 has abutment portion 63 formed thereon. Abutment portion 63 is claw-like and protrudes on the side surface of clutch body 58 facing transmission gear 57. In the present embodiment, abutment portion 63 is inserted into groove portion 61 of transmission gear 57 and is configured to slide within groove portion 61 when clutch body 58 rotates relative to transmission gear 57. In addition, abutment portion 63 is capable of abutting against at least one abutment target portion 65 at a predetermined rotational position of clutch body 58 relative to transmission gear 57. Abutment target portion 65 is formed on transmission gear 57. In the present embodiment, abutment target portion 65 is formed as the end portion of groove portion 61, but the present invention is not limited thereto. Abutment target portion 65 may also be formed as a partition wall portion set as a wall at least at one location inside groove portion 61 to divide groove portion 61. The switching of the contact and separation between abutment portion 63 and abutment target portion 65 according to the rotational direction of abutment portion 63 enables switching between the transmissive state and the non-transmissive state by transmission switching means 28. Abutment portion 63 may be formed integrally with first shaft portion 32, not being limited to the example where abutment portion 63 is formed on clutch body 58 separate from first shaft portion 32.

As shown in FIG. 3, transmission switching means 28, together with a part of first shaft portion 32 of first drive portion 26 and second gear 47 of second drive portion 27, is housed inside frame-shaped box portion 67, constituting a gearbox portion.

In addition, in the present embodiment, drive mechanism 15 (drive means 25, reduction gear 30, first drive portion 26, second drive portion 27, transmission switching means 28, and conversion means 35) is stored within storage member 70 and disposed within ventilation passage 5. Storage member 70 has a shape corresponding to the cross-section of ventilation passage 5 (shown in FIG. 4) within case body 3. In the present embodiment, storage member 70 is formed in a horizontally elongated shape. Storage member 70 is divided into upstream storage body 71 and downstream storage body 72. Between one storage body 71 and other storage body 72, drive means 25, reduction gear 30, first drive portion 26, second drive portion 27, transmission switching means 28, and conversion means 35 are sandwiched in the front-rear direction. As shown in FIG. 4, the front portion of other storage body 72 of storage member 70 is positioned facing exhaust port 7. Therefore, storage member 70 functions as a cover portion that prevents drive mechanism 15 shown in FIG. 3 from being visible from exhaust port 7 side. Storage member 70 engages between flow straightening portions 13a and 13b (shown in FIG. 1) of first fin 10, partitioning ventilation passage 5 (shown in FIG. 4) into upper and lower airflow portions.

Next, the operation of airflow direction adjustment apparatus 1 will be described. Hereinafter, with the rotation angle of drive means 25 being 0° and first fin 10 and second fin 11 being in the neutral position as a reference state, rotation in the clockwise direction as viewed from drive means 25 shall be termed forward rotation (positive direction of rotation angle), and rotation in the opposite direction shall be termed rearward rotation (negative direction of rotation angle).

When drive means 25 rotates in response to a signal from a control apparatus, first shaft portion 32 of first drive portion 26, which is coupled to drive means 25 via reduction gear 30, rotates in the same direction as drive means 25. When first shaft portion 32 rotates, first gear 33 coupled to first shaft portion 32 rotates integrally with the first shaft portion 32 in the same direction. As conversion gear 37 meshing with first gear 33 rotates, first crank 38 coupled coaxially to conversion gear 37 rotates in the same direction as conversion gear 37. Therefore, as first link body 40 moves in the left-right direction when cam pin 42 of first crank 38 engages first cam groove 43, coupling shaft portion 16, which engages first transmission groove 44 of first link body 40, moves in the left-right direction together with first link body 40, and therefore first fin 10 rotates in the left-right direction.

At this time, abutment portion 63 of clutch body 58, which rotates coaxially and integrally with first shaft portion 32, slides within groove portion 61 of transmission gear 57, and in a predetermined range where abutment portion 63 does not abut against abutment target portion 65, transmission gear 57 does not rotate in unison with the rotation of first shaft portion 32, and therefore second fin 11 does not rotate. In the present embodiment, in the rotation range of 90° in both forward and rearward directions, abutment portion 63 does not abut against abutment target portion 65, and due to the gear ratio between first gear 33 and conversion gear 37, first fin 10 can rotate to the maximum extent to the left and right (for example, rotate ±35°) in the range of rotation in both forward and rearward directions. Therefore, as long as first shaft portion 32 is rotated in a predetermined range to the left and right by drive means 25, regardless of whether drive means 25 is rotating forward and rearward, only first fin 10 can be rotated in the left-right direction without rotating second fin 11.

In addition, when first shaft portion 32 rotates by more than 90° in the forward direction by drive means 25 to a predetermined angle, for example 140° in the present embodiment, abutment portion 63 of clutch body 58, which rotates integrally and coaxially with first shaft portion 32, abuts against abutment target portion 65 of transmission gear 57. Therefore, in a range in which the rotation angle of first shaft portion 32 exceeds 140° in the forward direction, as long as first shaft portion 32, that is, clutch body 58, rotates forward, clutch body 58 and transmission gear 57 rotate forward integrally. When transmission gear 57 rotates, second gear 47 meshing with transmission gear 57 rotates in the opposite direction to transmission gear 57. Second shaft portion 46 rotates integrally with transmission gear 57 in the same direction as transmission gear 57, and second crank 48, which is coaxially coupled to second shaft portion 46, rotates in the same direction. Therefore, as second link body 50 moves in the up-down direction when cam pin 52 of second crank 48 engages second cam groove 53, coupling shaft portion 20, which engages second transmission groove 54 of second link body 50, moves in the up-down direction together with second link body 50, and therefore second fin 11 rotates in the up-down direction. At this time, as first shaft portion 32 rotates, first fin 10 rotates simultaneously with second fin 11 in the left-right direction. In the present embodiment, in the rotation range of 180° in the forward direction, the gear ratio between transmission gear 57 and second gear 47 enables second fin 11 to rotate up and down to the maximum extent (for example, ±45° rotation). On the other hand, even in this range, when first shaft portion 32 rotates rearward, abutment portion 63 moves away from abutment target portion 65, and therefore transmission gear 57, that is, second fin 11, ceases rotation, and only first fin 10 rotates.

Therefore, in the present embodiment, it is possible to rotate only first fin 10 based on the rotation angle and rotational direction of drive means 25.

FIG. 5 shows an example chart of the rotation angles of first fin 10 and second fin 11 relative to the rotation angle of drive means 25 in the present embodiment. In the illustrated example, when the rotation angle of drive means 25 is in the range of ±90°, only first fin 10 rotates in the left-right direction. In a range in which the rotation angle of drive means 25 exceeds 140°, both first fin 10 and second fin 11 rotate simultaneously when drive means 25 rotates forward, and only first fin 10 rotates when drive means 25 rotates rearward. When drive means 25 rotates forward, first fin 10 repeats reciprocating motion every 180° of rotation angle of drive means 25, while second fin 11 repeats reciprocating motion every 140° to 180° of rotation angle of drive means 25.

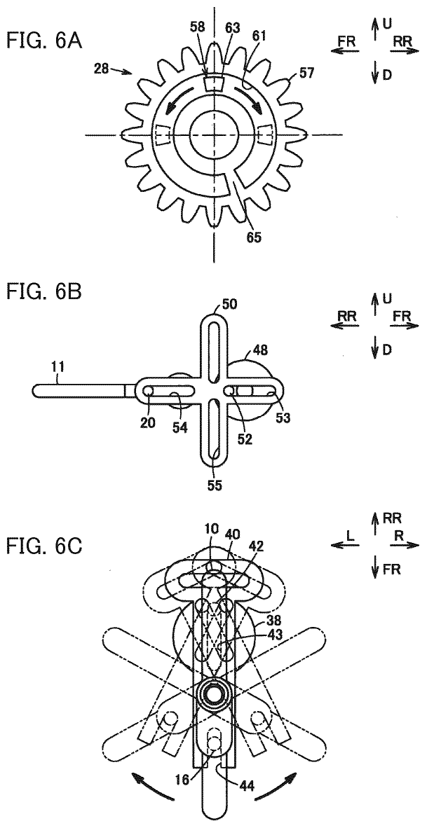

FIGS. 6 to 9 show the operation of transmission switching means 28 based on the example shown in FIG. 5, and the corresponding operation of first fin 10 and second fin 11.

When drive means 25 rotates forward and rearward in a range of ±90° from the neutral position, as shown in FIG. 6A, abutment portion 63 does not abut against abutment target portion 65, and as shown in FIG. 6B, second fin 11 maintains the neutral position without rotating. In addition, as shown in FIG. 6C, first crank 38 rotates left and right, causing cam pin 42 to move left and right, and coupling shaft portion 16 of first fin 10 is pressed left and right via first link body 40, causing first fin 10 to rotate left and right. Therefore, by alternately switching the rotational direction of drive means 25 in a range of ±90°, first fin 10 rotates alternately left and right, thereby obtaining the so-called swing effect where the airflow direction alternates left and right.

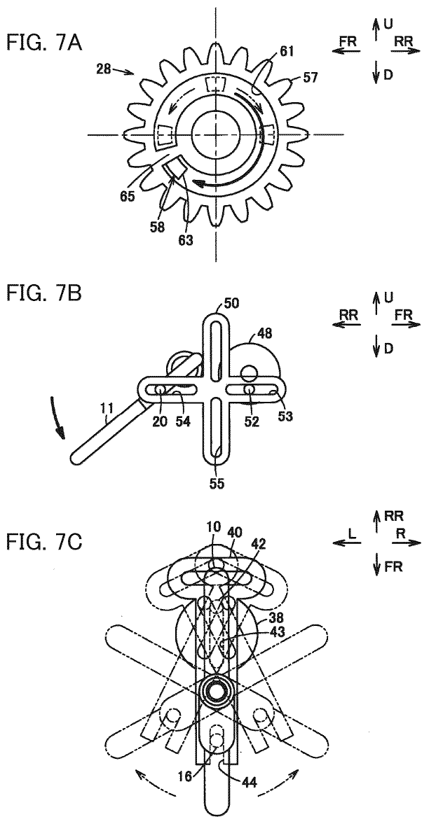

When drive means 25 rotates forward from 140° to 230°, as shown in FIG. 7A, abutment portion 63 abuts against abutment target portion 65, and transmission gear 57 rotates, and as shown in FIG. 7B, second crank 48 rotates forward, causing cam pin 52 to move downward, and coupling shaft portion 20 of second fin 11 is pressed downward via second link body 50, and the front side of second fin 11 rotates upward. In addition, for example, when drive means 25 is in a range of ±90°, abutment portion 63 does not abut against abutment target portion 65. Therefore, as drive means 25 rotates forward and rearward, as shown in FIG. 7C, first crank 38 rotates left and right, causing cam pin 42 to move left and right, and coupling shaft portion 16 of first fin 10 is pressed left and right via first link body 40, causing first fin 10 to rotate left and right, and a swing effect can be obtained by alternately switching the rotational direction of drive means 25.

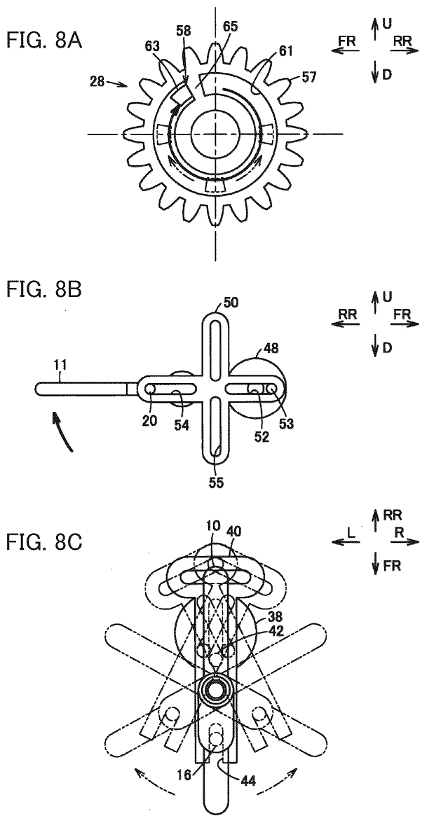

Furthermore, when drive means 25 rotates forward from 230° to 320°, as shown in FIG. 8A, abutment portion 63 abuts against abutment target portion 65, and transmission gear 57 rotates, and as shown in FIG. 8B, second crank 48 rotates forward, causing cam pin 52 to move upward, and coupling shaft portion 20 of second fin 11 is pressed upward via second link body 50, and the front side of second fin 11 rotates downward to the neutral position. In addition, for example, when drive means 25 is in a range of 180°±90°, abutment portion 63 does not abut against abutment target portion 65. Therefore, as drive means 25 rotates forward and rearward, as shown in FIG. 8C, first crank 38 rotates left and right, causing cam pin 42 to move left and right, and coupling shaft portion 16 of first fin 10 is pressed left and right via first link body 40, causing first fin 10 to rotate left and right, and a swing effect can be obtained by alternately switching the rotational direction of drive means 25.

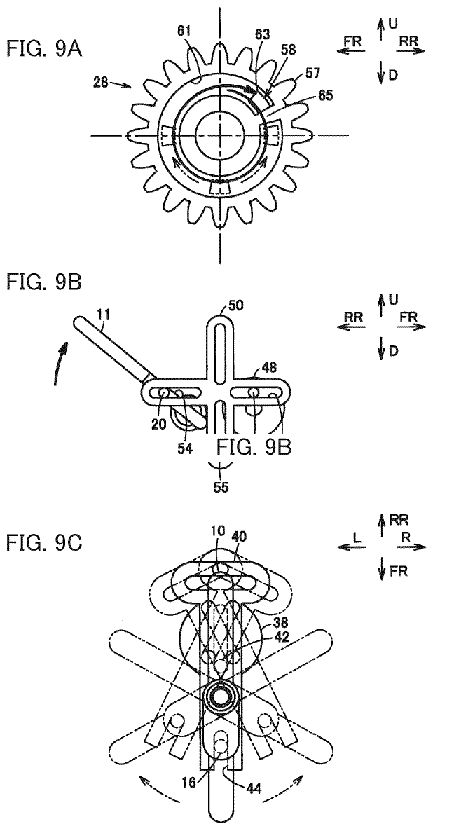

When drive means 25 rotates forward from 320° to 410°, as shown in FIG. 9A, abutment portion 63 abuts against abutment target portion 65, and transmission gear 57 rotates, and as shown in FIG. 9B, second crank 48 rotates forward, causing cam pin 52 to move upward, and coupling shaft portion 20 of second fin 11 is pressed upward via second link body 50, and the front side of second fin 11 rotates downward. In addition, for example, when drive means 25 is in a range of 180°±90 °, abutment portion 63 does not abut against abutment target portion 65. Therefore, as drive means 25 rotates forward and rearward, as shown in FIG. 9C, first crank 38 rotates left and right, causing cam pin 42 to move left and right, and coupling shaft portion 16 of first fin 10 is pressed left and right via first link body 40, causing first fin 10 to rotate left and right, and a swing effect can be obtained by alternately switching the rotational direction of drive means 25.

As described above, according to the present embodiment, second drive portion 27 for rotating second fin 11 is disposed so that rotational axis A4 is parallel to first drive portion 26 for rotating first fin 10, and transmission switching means 28 can switch between a transmissive state in which first drive portion 26 transmits the driving force received from drive means 25 to second drive portion 27, and a non-transmissive state in which first drive portion 26 does not transmit the driving force received from drive means 25 to second drive portion 27. This makes it possible to realize airflow direction adjustment apparatus 1 that can rotate only one of the fins, in the present embodiment, first fin 10, without rotating second fin 11, while constructing a simple and compact mechanism that can rotate first fin 10 and second fin 11 using one drive means 25.

In particular, when airflow direction adjustment apparatus 1 is a horizontal type, there is a higher demand for moving first fin 10 than second fin 11. Therefore, airflow direction adjustment apparatus 1 that can satisfy such demand can be provided.

In addition, since there is only one drive means 25, the manufacturing cost can be reduced as compared to a configuration where drive means is provided for each fin.

Specifically, first shaft portion 32 of first drive portion 26 is inserted with a gap into opening portion 60 of transmission gear 57 of transmission switching means 28, which meshes with second gear 47 for rotating second fin 11, and abutment target portion 65 is provided on transmission gear 57, and abutment portion 63 is provided on clutch body 58, which rotates in accordance with the rotation of first shaft portion 32. Thus, when first shaft portion 32 rotates forward and rearward in accordance with the forward and rearward rotation of drive means 25, contact and separation of abutment portion 63 with respect to abutment target portion 65 is switched depending on the rotational direction, thereby switching between a transmissive state and a non-transmissive state. Therefore, by simply switching the rotational direction of drive means 25, first fin 10 and second fin 11 can be rotated simultaneously, or only first fin 10 can be rotated.

In addition, by forming groove portion 61 around opening portion 60 and extending in a circumferential direction in transmission gear 57 and inserting abutment portion 63 of clutch body 58 into groove portion 61, it is possible to dispose transmission gear 57 and clutch body 58 close to each other in the axial direction, resulting in a more compact configuration.

Furthermore, by providing conversion means 35 that converts the rotation of first drive portion 26 due to the driving force received from drive means 25 into the rotation of first fin 10, a mechanism can be simply constructed in which the rotation of first drive portion 26 rotates first fin 10, whose rotational axis direction intersects or is perpendicular to that of first drive portion 26.

In addition, by storing drive mechanism 15 including drive means 25 inside storage member 70 and disposing the same inside case body 3, there are no parts or structures that protrude outside case body 3, and space can be saved.

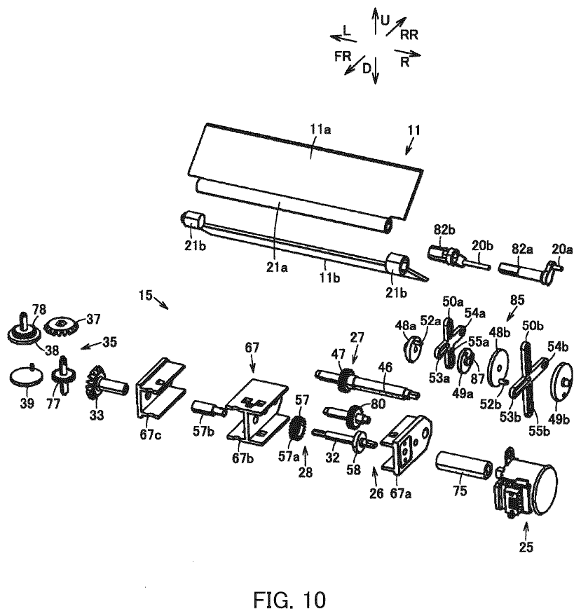

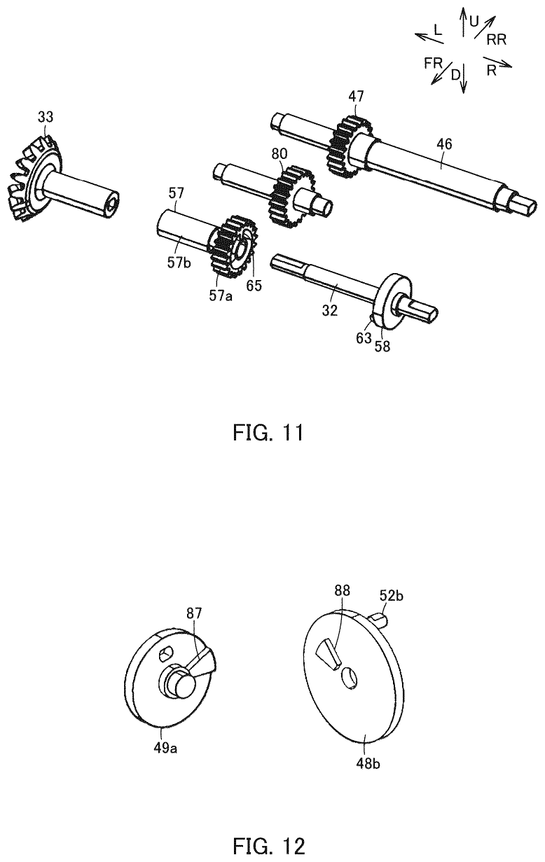

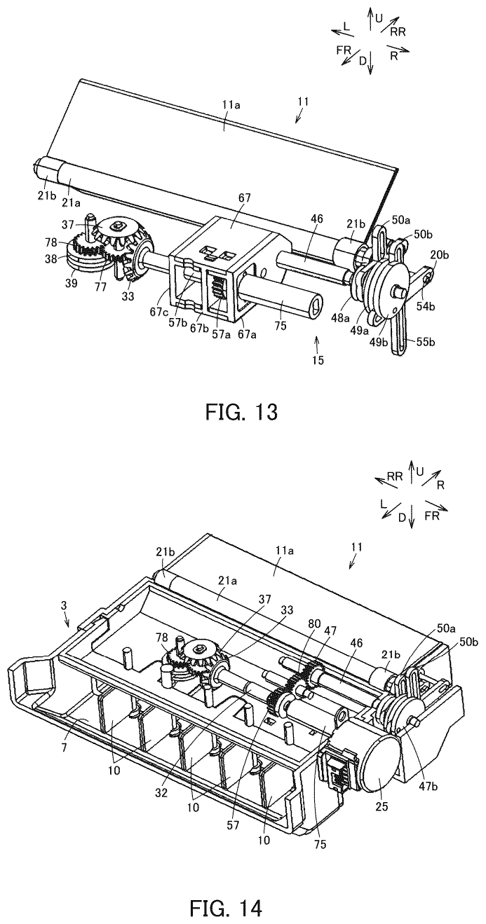

Next, Embodiment 2 will be described with reference to FIGS. 10 to 19. The same reference numerals are given to the same configurations and actions as in Embodiment 1, and the description thereof will be omitted.

In the present embodiment, as shown in FIGS. 10, 11, 13, and 14, shaft 75 coupled to the rotational axis of drive means 25 is connected to clutch body 58, and transmission gear 57 is divided into gear portion 57a and cylindrical shaft portion 57b. Box portion 67 is divided into box members 67a, 67b, and 67c in the axial direction of first drive portion 26, and clutch body 58 and gear portion 57a of transmission gear 57 are positioned between box members 67a and 67b, and shaft portion 57b of transmission gear 57 is positioned between box members 67b and 67c. Furthermore, first shaft portion 32, which rotates integrally with clutch body 58, is inserted into transmission gear 57 and coupled to first gear 33. Conversion gear 77 is coupled coaxially to the lower portion of conversion gear 37, which meshes with first gear 33. In addition, conversion gear 78 meshing with conversion gear 77 is integrally formed on first crank 38.

Second drive portion 27 has second shaft portion 46 extending to the right side relative to second gear 47. Transmission gear 80, which forms a part of transmission switching means 28, is interposed between second gear 47 and transmission gear 57. Transmission gear 80 has a rotational axis along first drive portion 26 and second drive portion 27. Transmission gear 80 converts the rotational direction of transmission gear 57 and second gear 47 to the same direction. Therefore, if the rotational directions of transmission gear 57 and second gear 47 do not need to be the same, transmission gear 80 is not necessary.

In the present embodiment, second fin 11 consists of one fin piece 11a and other fin piece 11b. One fin piece and other fin piece 11a and 11b are separate from each other and disposed to have coaxial rotational axes. For example, one fin piece and other fin piece 11a and 11b have an area of at least half the cross-sectional area of ventilation passage 5. When one fin piece and other fin piece 11a and 11b rotate integrally in the same direction while integrally overlapping, second fin 11 functions as a single fin for adjusting the airflow direction, and when one fin piece and other fin piece 11a and 11b rotate in opposite directions and move away from each other, second fin 11 functions as a shut-off valve to block ventilation passage 5.

The driving force from second drive portion 27 to second fin 11 is transmitted to one fin piece 11a via one second link body 50a, which is one link, and to other fin piece 11b via other second link body 50b, which is the other link.

One second link body and other second link body 50a and 50b have the same shape as second link body 50 of Embodiment 1. That is, one second link body and other second link body 50a and 50b are formed in a plate shape having a thickness in the left-right direction, extending in the front-rear and up-down directions, and in the present embodiment, are formed in a cross shape. One second link body and other second link body 50a and 50b have one second cam groove and other second cam groove 53a and 53b formed in the front portion in the shape of a long hole extending in the front-rear direction, one second transmission groove and other second transmission groove 54a and 54b formed in the rear end portion in the shape of a long hole extending in the front-rear direction, and one regulating groove and other regulating groove 55a and 55b formed in the shape of a long hole extending in the up-down direction for regulating the position of second link body 50. The shape of one second link body and other second link body 50a and 50b is not limited to a cross shape and may also be a T-shape or the like.

One second link body and other second link body 50a and 50b are coupled to one fin piece and other fin piece 11a and 11b at the positions of one second transmission groove and other second transmission groove 54a and 54b. In the present embodiment, one coupling shaft portion and other coupling shaft portion 20a and 20b are slidably and rotatably inserted into one second transmission groove and other second transmission groove 54a and 54b. One coupling shaft portion and other coupling shaft portion 20a and 20b are integrally formed with one crank shaft portion and other crank shaft portion 82a and 82b, which are separate bodies from one fin piece and other fin piece 11a and 11b, for example. One crank shaft portion and other crank shaft portion 82a and 82b are each formed axially and are coupled to one fin piece and other fin piece 11a and 11b along the rotational axis. Since one coupling shaft portion and other coupling shaft portion 20a and 20b are positioned radially rearward and away from the central axis of one crank shaft portion and other crank shaft portion 82a and 82b, the rotation of second drive portion 27 is converted into rotation of fin pieces 11a and 11b by the movement of one second link body and other second link body 50a and 50b in front-rear direction and the up-down direction. In the present embodiment, one fin piece 11a has a cylindrical rotating portion 21a along the longitudinal direction thereof, and other fin piece 11b has other rotating portion 21b coaxially disposed at both end portions of rotating portion 21a of one fin piece 11a. Other crank shaft portion 82b is coupled to other rotating portion 21b, and one crank shaft portion 82a is inserted through other crank shaft portion 82b and other rotating portion 21b and coupled to one end portion of one rotating portion 21a.

In addition, one cam pin and other cam pin 52a and 52b of one second crank and other second crank 48a and 48b are slidably and rotatably inserted into one second cam groove and other second cam groove 53a and 53b of one second link body and other second link body 50a and 50b. One second crank and other second crank 48a and 48b are formed in a disk shape, with one cam pin and other cam pin 52a and 52b protruding laterally. One cam pin and other cam pin 52a and 52b are positioned radially away from the central axes of one second crank and other second crank 48a and 48b. In addition, one cam pin and other cam pin 52a and 52b are coupled to one second rotating body and other second rotating body 49a and 49b through one second link body and other second link body 50a and 50b. One second rotating body 49a is formed in a disk shape having a diameter substantially equal to that of one second crank 48a, while other second rotating body 49b is formed in a disk shape having a diameter substantially equal to that of other second crank 48b. Second rotating body 49 is rotatably supported on case body 3 side, for example.

One second crank and other second crank 48a and 48b, and one second rotating body and other second rotating body 49a and 49b are positioned coaxially with second drive portion 27, namely second shaft portion 46 and second gear 47. One second crank 48a is coupled coaxially to the tip end portion of second shaft portion 46. That is, one second crank 48a is rotated directly by second drive portion 27, and one second link body 50a receives the driving force of second drive portion 27 and rotates in unison. In other words, one fin piece 11a is rotated directly by second drive portion 27.

Airflow direction adjustment apparatus 1 includes link transmission switching means 85. Link transmission switching means 85 is capable of switching between a transmissive state in which one second link body 50a transmits the driving force received from second drive portion 27 to other second link body 50b, and a non-transmissive state in which one second link body 50a does not transmit the driving force received from second drive portion 27 to other second link body 50b. Therefore, other second link body 50b can indirectly receive the driving force from the second drive portion 27 via the link transmission switching means 85 in the transmissive state. In other words, other fin piece 11b is rotated indirectly by second drive portion 27.

In the present embodiment, link transmission switching means 85 is configured, as shown in FIG. 12, with one second rotating body 49a and other second crank 48b.

Second rotating body 49a has abutment portion 87 formed thereon. Abutment portion 87 is claw-like and protrudes on the side surface facing other second crank 48b in one second rotating body 49a. Abutment portion 87 is formed in a rib shape extending radially outward. Similarly, other second crank 48b has abutment target portion 88 formed to be contacted and separated from abutment portion 87. Abutment target portion 88 is claw-like and protrudes on the side surface facing one second rotating body 49a in other second crank 48b. Abutment target portion 88 is formed in a rib shape extending radially outward. Abutment portion 87 is capable of abutting against abutment target portion 88 at a predetermined rotational position of second rotating body 49a relative to other second crank 48b. The switching of the contact and separation between abutment portion 87 and abutment target portion 88 according to the rotational direction of abutment portion 87 enables switching between the transmissive state and the non-transmissive state by link transmission switching means 85.

Next, the operation of airflow direction adjustment apparatus 1 will be described.

When drive means 25 rotates in response to a signal from the control apparatus, first shaft portion 32 of first drive portion 26 rotates in the same direction as drive means 25. When first shaft portion 32 rotates, first gear 33 coupled to first shaft portion 32 rotates integrally with first shaft portion 32 in the same direction, and conversion gear 37 meshing with first gear 33 rotates, causing conversion gear 77 coupled coaxially with conversion gear 37 to rotate in the same direction as conversion gear 37, and first crank 38, whose conversion gear 78 meshes with conversion gear 77, to rotate in the opposite direction to conversion gear 77. Therefore, similar to Embodiment 1, first fin 10 rotates in the left-right direction.

At this time, abutment portion 63 of clutch body 58, which rotates coaxially and integrally with first shaft portion 32, slides within groove portion 61 of transmission gear 57, and in a predetermined range where abutment portion 63 does not abut against abutment target portion 65, transmission gear 57 does not rotate in unison with the rotation of first shaft portion 32, and therefore second fin 11 does not rotate. In the present embodiment, in the rotation range of 90° in both the forward and rearward directions, abutment portion 63 does not abut against abutment target portion 65, and due to the gear ratio between first gear 33 and conversion gear 37, first fin 10 can rotate to the maximum extent to the left and right in the rotation range of 90° in both the forward and rearward directions. Therefore, as long as first shaft portion 32 is rotated in a predetermined range to the left and right by drive means 25, regardless of whether drive means 25 is rotating forward and rearward, only first fin 10 can be rotated in the left-right direction without rotating second fin 11.

In addition, when the first shaft portion 32 rotates by more than 90° in the rearward direction by drive means 25 to a predetermined angle, for example 140° in the present embodiment, abutment portion 63 of clutch body 58, which rotates integrally and coaxially with first shaft portion 32, abuts against abutment target portion 65 of transmission gear 57. Therefore, in the range where first shaft portion 32 exceeds 140° in the rearward direction, as long as first shaft portion 32, that is, clutch body 58, rotates forward, clutch body 58 and transmission gear 57 will rotate forward integrally. When transmission gear 57 rotates, transmission gear 80 meshing with transmission gear 57 rotates in the opposite direction to transmission gear 57, second gear 47 meshing with transmission gear 57 rotates in the opposite direction to transmission gear 80, that is, the same direction as transmission gear 57, that is, the rearward direction, second shaft portion 46 rotates integrally with second gear 47 in the same direction as second gear 47, and one second crank 48a coaxially coupled to second shaft portion 46 rotates in the same direction. Therefore, as one second link body 50a moves in the up-down direction when cam pin 52a of one second crank 48a engages second cam groove 53a, coupling shaft portion 20a, which engages one second transmission groove 54a of one second link body 50a, moves in the up-down direction together with one second link body 50a, and therefore one fin piece 11a of second fin 11 rotates in the up-down direction. In addition, when one second rotating body 49a coupled to one second crank 48a rotates in the same direction as one second crank 48a, abutment portion 87 formed on one second rotating body 49a rotates and abuts against abutment target portion 88 formed on other second crank 48b, causing other second crank 48b to rotate in the same direction. Therefore, as other second link body 50b moves in the up-down direction when other cam pin 52b of other second crank 48b engages other second cam groove 53b, other coupling shaft portion 20b, which engages other second transmission groove 54b of other second link body 50b, moves in the up-down direction together with other second link body 50b, and therefore other fin piece 11b of second fin 11 also rotates in the same vertical direction integrally with one fin piece 11a. Therefore, second fin 11 acts as if second fin 11 were a single fin. At this time, as first shaft portion 32 rotates, first fin 10 rotates simultaneously with second fin 11 in the left-right direction.

On the other hand, even within this range, when first shaft portion 32 rotates forward, abutment portion 63 moves away from abutment target portion 65, and therefore transmission gear 57, that is, one fin piece and other fin piece 11a and 11b of second fin 11, cease rotation, and only first fin 10 rotates. However, when first shaft portion 32 rotates approximately one full revolution in the forward direction by drive means 25, abutment portion 63 of clutch body 58, which rotates coaxially and integrally with first shaft portion 32, abuts against abutment target portion 65 of transmission gear 57 from the forward direction, causing clutch body 58 and transmission gear 57 to rotate integrally in the forward direction. When transmission gear 57 rotates, transmission gear 80 meshing with transmission gear 57 rotates in the opposite direction to transmission gear 57, second gear 47 meshing with transmission gear 57 rotates in the opposite direction to transmission gear 80, that is, the same direction as transmission gear 57, that is, the forward direction, second shaft portion 46 rotates integrally with second gear 47 in the same direction as second gear 47, and one second crank 48a coaxially coupled to second shaft portion 46 rotates in the same direction. Therefore, as one second link body 50a moves in the up-down direction when cam pin 52a of one second crank 48a engages second cam groove 53a, coupling shaft portion 20a, which engages one second transmission groove 54a of one second link body 50a, moves in the up-down direction together with one second link body 50a, and therefore one fin piece 11a of second fin 11 rotates in the up-down direction. On the other hand, when one second rotating body 49a coupled to one second crank 48a rotates in the same direction as one second crank 48a, abutment portion 87 formed on one second rotating body 49a rotates in a direction away from abutment target portion 88 formed on other second crank 48b, and other second crank 48b does not rotate. Therefore, other fin piece 11b maintains the position thereof without being coupled to one fin piece 11a. Therefore, when drive means 25 is rotated forward from a state in which other fin piece 11b is at the maximum rotated position, one fin piece 11a is moved to the maximum rotated position, and second fin 11 acts as a shut-off valve that blocks ventilation passage 5.

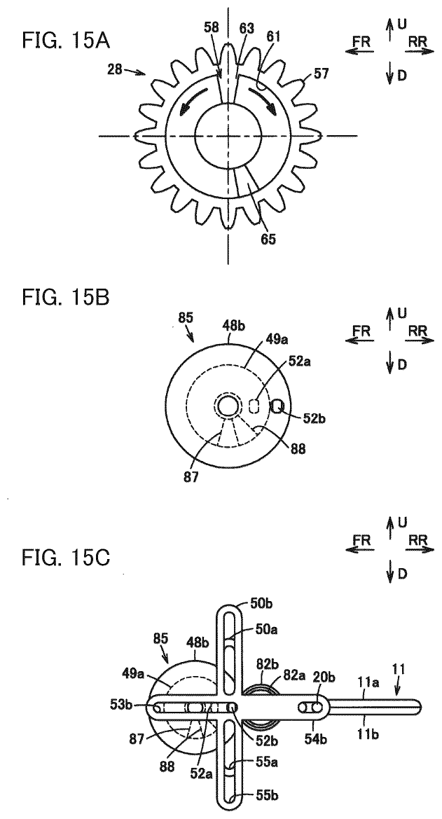

The operation of transmission switching means 28 and link transmission switching means 85 based on this example, and the corresponding operation of second fin 11, are shown in FIGS. 15 to 19. The operation of first fin 10 is essentially the same as in Embodiment 1, and the description thereof will be omitted.

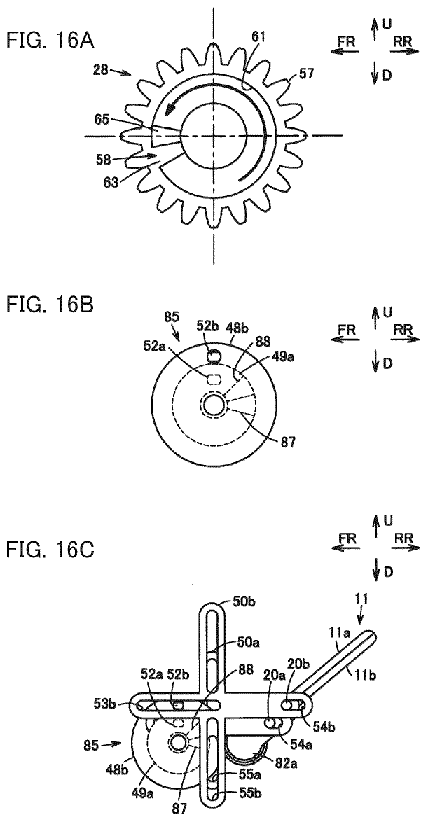

When drive means 25 rotates rearward by more than 140° from the neutral position shown in FIGS. 15A to 15C, abutment portion 63 abuts against abutment target portion 65, as shown in FIG. 16A, and transmission gear 57 rotates, causing transmission gear 80 meshing with transmission gear 57 to rotate, second gear 47 meshing with transmission gear 80 to rotate, and one second crank 48a coupled to second shaft portion 46 coaxial with second gear 47 to rotate in the rearward direction. Therefore, as shown in FIG. 16B, when abutment portion 87 of one second rotating body 49a coupled to one second crank 48a comes into contact with abutment target portion 88 of other second crank 48b, other second crank 48b also rotates in the rearward direction. As a result, as shown in FIG. 16C, one coupling shaft portion 20a is pressed upward via one second link body 50a, and other coupling shaft portion 20b is pressed upward via other second link body 50b, causing front sides of one fin piece and other fin piece 11a and 11b to rotate downward integrally. For example, when one second crank and other second crank 48a and 48b rotate by 90°, second fin 11 reaches the maximum downward rotated position.

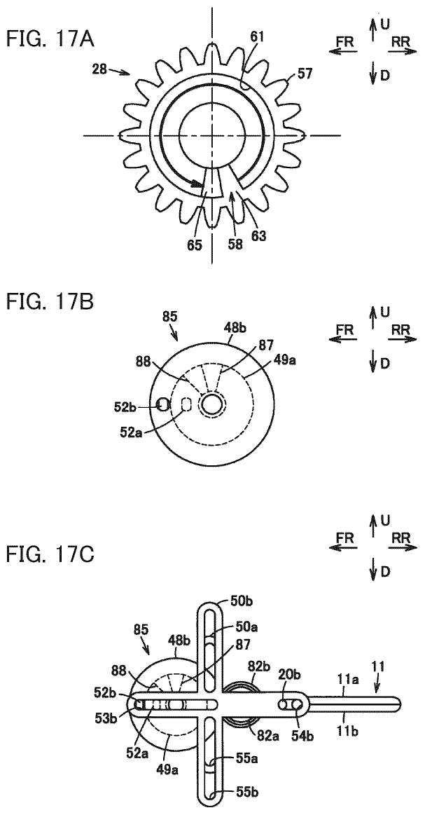

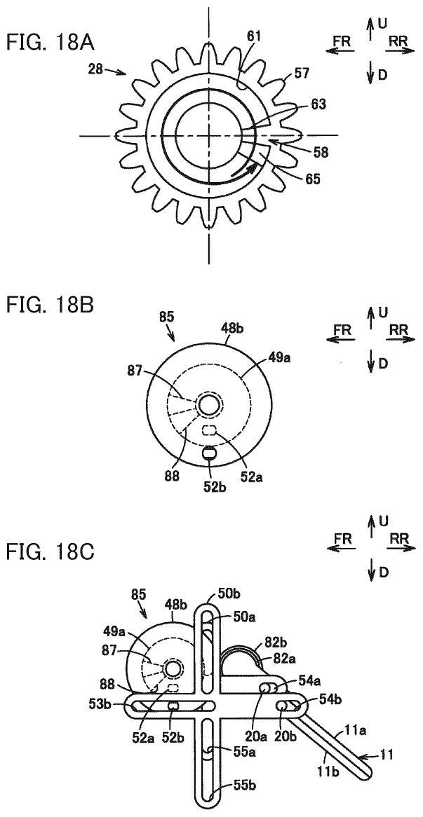

When drive means 25 further rotates rearward, as shown in FIG. 17A, abutment portion 63 abuts against abutment target portion 65, and transmission gear 57 rotates, causing transmission gear 80 meshing with transmission gear 57 to rotate, second gear 47 meshing with transmission gear 80 to rotate, and one second crank 48a coupled to second shaft portion 46 coaxial with second gear 47 to rotate. Therefore, as shown in FIG. 17B, when abutment portion 87 of one second rotating body 49a coupled to one second crank 48a comes into contact with abutment target portion 88 of other second crank 48b, other second crank 48b also rotates. As a result, as shown in FIG. 17C, one coupling shaft portion 20a is pressed downward via one second link body 50a, and other coupling shaft portion 20b is pressed downward via other second link body 50b, causing the front sides of one fin piece and other fin piece 11a and 11b to rotate upward integrally and return to the neutral position. For example, when one second crank and other second crank 48a and 48b rotate by an additional 90° from the state shown in FIG. 16B, second fin 11 returns to the neutral position. When drive means 25 further rotates rearward, second fin 11 can rotate from the neutral position shown in FIG. 17C to the maximum upward position shown in FIGS. 18A to 18C. For example, when one second crank and other second crank 48a and 48b rotate by an additional 90° from the state shown in FIG. 17B, second fin 11 returns to the neutral position. As drive means 25 further rotates rearward, second fin 11 rotates downward once more. Therefore, as long as drive means 25 continues to rotate rearward, second fin 11 reciprocates up and down.

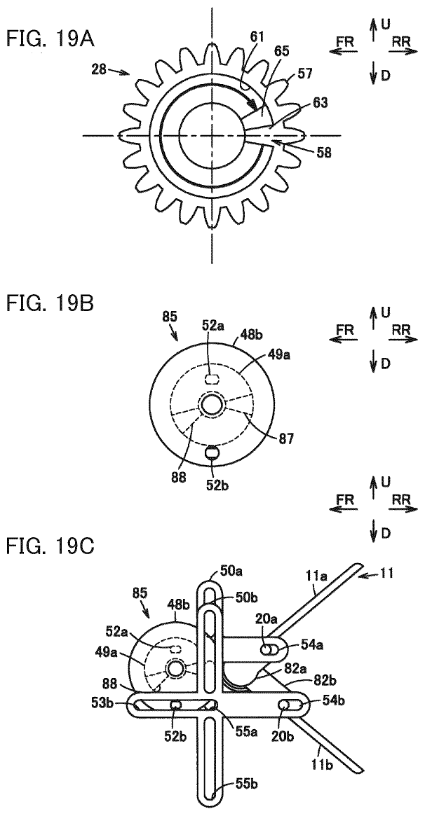

On the other hand, when drive means 25 is rotated forward with the front side of second fin 11 rotated to the maximum upward position, as shown in FIG. 19A, abutment portion 63 abuts against abutment target portion 65 from the forward direction, and transmission gear 57 rotates, and as a result, as shown in FIG. 19B, one second crank 48a rotates forward, causing one cam pin 52a to move upward, and one coupling shaft portion 20a is pressed upward via one second link body 50a, and the front side of only one fin piece 11a of second fins 11 rotates downward. Therefore, as shown in FIG. 19C, one fin piece 11a and other fin piece 11b are positioned open up and down, and second fin 11 blocks ventilation passage 5 to prevent airflow.

In this way, by having a configuration similar to that of Embodiment 1, such as being equipped with a transmission switching means 28, it is possible to construct a simple and compact mechanism that can rotate first fin 10 and second fin 11 using one drive means 25, while realizing airflow direction adjustment apparatus 1 that can rotate only one fin piece, in the present embodiment, first fin 10, without rotating second fin 11, thereby achieving the same effects as those of Embodiment 1.

In addition, link transmission switching means 85 is provided in one second link body and other second link body 50a and 50b that transmit driving force to one fin piece and other fin piece 11a and 11b of second fin 11, and link transmission switching means 85 makes it possible to switch between a transmissive state in which one second link body 50a transmits the driving force received from second drive portion 27 to other second link body 50b, and a non-transmissive state in which one second link body 50a does not transmit the driving force received from second drive portion 27 to other second link body 50b. This makes it possible to construct a simple and compact mechanism that can rotate each of one fin piece 11a and other fin piece 11b of second fin 11 using one drive means 25, while also enabling operation in which only one fin piece, in the present embodiment, one fin piece 11a, is rotated, without rotating other fin piece 11b. Therefore, it is possible to configure a shut-off valve that blocks ventilation passage 5 by changing the rotation angles of one fin piece 11a and other fin piece 11b using second fin 11. This eliminates the need for a separate shut-off valve or mechanisms to operate the shut-off valve, enabling the realization of simplified airflow direction adjustment apparatus 1.

In each embodiment, transmission switching means 28 is not limited to a configuration in which the transmissive state and the non-transmissive state are switched by using the contact and separation between abutment portion 63 that rotates integrally with first shaft portion 32 and abutment target portion 65 provided on transmission gear 57 that rotates freely relative to first shaft portion 32, but may have any configuration, such as a configuration in which transmission gear 57 rotates integrally with first shaft portion 32, and transmission gear 57 and second gear 47 are engaged/disengaged by first shaft portion 32 sliding in the axial direction, thereby switching between the transmissive state and the non-transmissive state.

In addition, airflow direction adjustment apparatus 1 is not limited to an apparatus for an automobile, and may be used for any other desired purpose.

### INDUSTRIAL APPLICABILITY

For example, the present invention can be suitably used as an airflow direction adjustment apparatus for air conditioning of an automobile.

### REFERENCE SIGNS LIST

1 Airflow direction adjustment apparatus
5 Ventilation passage
10 First fin
11 Second fin
11a One fin piece
11b Other fin piece
25 Drive means
26 First drive portion
27 Second drive portion
28 Transmission switching means
32 First shaft portion that is a shaft portion
35 Conversion means
47 Second gear that is a gear
50a One second link body that is one link
50b Other second link body which is the other link
57 Transmission gear
60 Opening portion
61 Groove portion
63 Abutment portion
65 Abutment target portion
85 Link transmission switching means
A1, A2, A3, A4 Rotational axis

What is claimed is:

1. An airflow direction adjustment apparatus comprising:
a ventilation passage;
a first fin that has a rotational axis in a first direction intersecting a ventilation direction of the ventilation passage and changes an airflow direction by rotating;
a second fin that has a rotational axis in a second direction intersecting the ventilation direction and the first direction and changes an airflow direction by rotating;
drive means;
a first drive portion that rotates upon receiving driving force from the drive means and rotates the first fin;
a second drive portion that has a rotational axis along the first drive portion and rotates the second fin by rotating; and
transmission switching means capable of switching between a transmissive state in which the first drive portion transmits the driving force received from the drive means to the second drive portion, and a non-transmissive state in which the first drive portion does not transmit the driving force received from the drive means to the second drive portion.

2. The airflow direction adjustment apparatus according to claim 1, wherein
the drive means is capable of forward and rearward rotation,
the first drive portion includes a shaft portion that is disposed to extend in the second direction and is rotated forward and rearward according to rotation of the drive means,
the second drive portion includes a gear that has a rotational axis parallel to the shaft portion and rotates the second fin by rotating, and
the transmission switching means includes a transmission gear including an opening portion through which the shaft portion is inserted with a gap, and an abutment target portion, the transmission gear being disposed coaxially with the shaft portion and meshing with the gear, and an abutment portion that rotates according to rotation of the shaft portion and is capable of abutting against the abutment target portion, and is capable of switching the transmissive state and the non-transmissive state by switching contact and separation of the abutment portion with respect to the abutment target portion according to a rotational direction of the abutment portion.

3. The airflow direction adjustment apparatus according to claim 2, wherein
the transmission gear includes a groove portion located around the opening portion and extending in a circumferential direction, and
the abutment portion is inserted into the groove portion.

4. The airflow direction adjustment apparatus according to claim 1,
wherein the second fin consists of one fin piece and the other fin piece, which are separate from each other, and
further comprising:
one link and the other link for transmitting driving force to the one fin piece and the other fin piece; and
link transmission switching means capable of switching between a transmissive state in which the one link transmits the driving force received from the second drive portion to the other link, and a non-transmissive state in which the one link does not transmit the driving force received from the second drive portion to the other link.

5. The airflow direction adjustment apparatus according to claim 1,
wherein the first drive portion has a rotational axis in a direction intersecting the rotational axis of the first fin, and
further comprising conversion means for converting rotation of the first drive portion due to the driving force received from the drive means into rotation of the first fin.

6. The airflow direction adjustment apparatus according to claim 2,
wherein the first drive portion has a rotational axis in a direction intersecting the rotational axis of the first fin, and
further comprising conversion means for converting rotation of the first drive portion due to the driving force received from the drive means into rotation of the first fin.

7. The airflow direction adjustment apparatus according to claim 3,
wherein the first drive portion has a rotational axis in a direction intersecting the rotational axis of the first fin, and
further comprising conversion means for converting rotation of the first drive portion due to the driving force received from the drive means into rotation of the first fin.

8. The airflow direction adjustment apparatus according to claim 4,
wherein the first drive portion has a rotational axis in a direction intersecting the rotational axis of the first fin, and
further comprising conversion means for converting rotation of the first drive portion due to the driving force received from the drive means into rotation of the first fin.
